(19) United States
(12) Patent Application Publication
(10) Pub. No.: US 2026/0031250 A1
(43) Pub. Date: Jan. 29, 2026

(54) INSULATED WIRE

(71) Applicant: Proterial, Ltd., Tokyo (JP)

(72) Inventors: Takami USHIWATA, Toyko (JP); Yuki HONDA, Toyko (JP)

(21) Appl. No.: 19/246,323

(22) Filed: Jun. 23, 2025

(30) Foreign Application Priority Data
Jul. 24, 2024 (JP) 2024-118580
Feb. 13, 2025 (JP) 2025-021182

(51) Int. Cl. H01B 3/30; C08G 73/10; C09D 179/08; H01B 13/00; H01B 13/06

(52) U.S. Cl. CPC H01B 3/306; C08G 73/1042; C08G 73/1067; C08G 73/1071; C09D 179/08; H01B 13/0016; H01B 13/06

(57) ABSTRACT

An insulated wire having high adhesiveness between layers forming an insulation film is provided. The insulated wire of the present disclosure includes a conductor, and the insulation film that coats the conductor. The insulation film includes polyimide and an inorganic filler. A storage modulus of the insulation film at 370° C. is 0.9 GPa or less.

### CROSS-REFERENCE TO RELATED APPLICATIONS

This application claims the benefit of Japanese Patent Application No. 2024-118580 filed on Jul. 24, 2024, with the Japan Patent Office and Japanese Patent Application No. 2025-021182 filed on Feb. 13, 2025, with the Japan Patent Office, the entire disclosures of which are incorporated herein by reference.

### BACKGROUND

The present disclosure relates to an insulated wire.

International Patent Application Publication No. 2018/230706 discloses an insulated wire. The insulated wire includes a conductor, and an insulation film. The insulation film coats the conductor.

### SUMMARY

The insulation film includes laminated layers. In order to increase surge resistance of the insulation film, an inorganic filler may be blended into the insulation film. In this case, polymer components that are present on an interface between the layers forming the insulation film decrease. When the polymer components present on the interface decrease, entanglement of molecules of the polymer components between the layers also decreases. Consequently, adhesiveness between the layers forming the insulation film is reduced.

In one aspect of the present disclosure, it is preferable to provide an insulated wire having high adhesiveness between the layers forming the insulation film.

One aspect of the present disclosure is an insulated wire including a conductor, and an insulation film coating the conductor. The insulation film includes polyimide, and an inorganic filler. A storage modulus of the insulation film at 370° C. is 0.9 GPa or less.

In the insulated wire of one aspect of the present disclosure, adhesiveness between layers forming the insulation film is high.

### BRIEF DESCRIPTION OF THE DRAWINGS

An example embodiment of the present disclosure will be described hereinafter with reference to the accompanying drawings, in which:

FIG. 1 is an explanatory diagram showing a configuration of a manufacturing apparatus for a flat enameled copper wire;

FIG. 2 is a sectional view showing a cross-sectional shape of a flat copper wire;

FIG. 3 is a sectional view showing a cross-sectional shape of a flat copper drawn wire;

FIG. 4 is a sectional view showing a cross-sectional shape of the flat enameled copper wire;

FIG. 5 is a graph showing transitions of temperatures and storage moduli when measuring the storage moduli in examples; and

FIG. 6 is an explanatory diagram showing a method for performing a cut and stretch test.

### DETAILED DESCRIPTION OF EXEMPLARY EMBODIMENTS

### First Embodiment

### Method for Manufacturing Flat Enameled Copper Wire 25

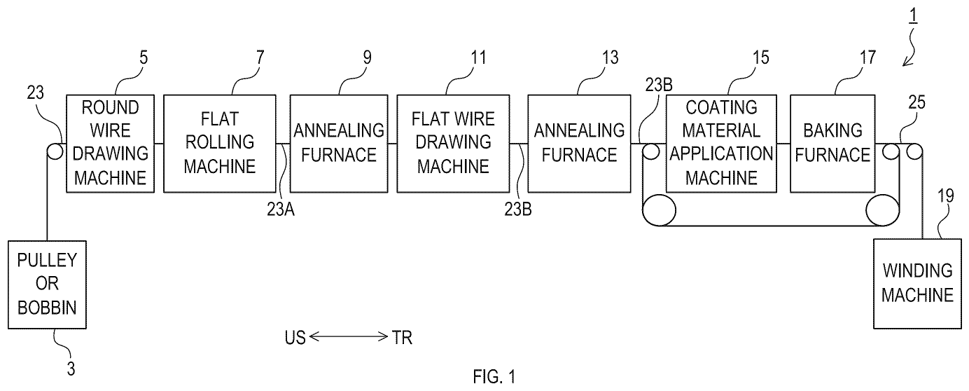

A method for manufacturing a flat enameled copper wire 25 is explained with reference to FIG. 1 to FIG. 4. The flat enameled copper wire 25 corresponds to an insulated wire. A manufacturing apparatus 1 shown in FIG. 1 is used in the method for manufacturing the flat enameled copper wire 25. The manufacturing apparatus 1 includes a pulley or bobbin 3, a round wire drawing machine 5, a flat rolling machine 7, an annealing furnace 9, a flat wire drawing machine 11, an annealing furnace 13, a coating material application machine 15, a baking furnace 17, and a winding machine 19.

A conductor 23 having a linear shape is wound around the pulley or bobbin 3. The conductor 23 is drawn out from the pulley or bobbin 3, travels along a path that passes through the round wire drawing machine 5, the flat rolling machine 7, the annealing furnace 9, the flat wire drawing machine 11, the annealing furnace 13, the coating material application machine 15, and the baking furnace 17 in this order, and is wound up by the winding machine 19. Note that a flat copper drawn wire 23B to be described below, which is the conductor 23 subjected to some processes, travels a section including the coating material application machine 15 and the baking furnace 17 multiple times.

A material for the conductor 23 is copper or a copper alloy. A cross-sectional shape of the conductor 23 is circular until a flat rolling to be described below is performed. The cross section of the conductor 23 refers to a section perpendicular to a longitudinal axis of the conductor 23.

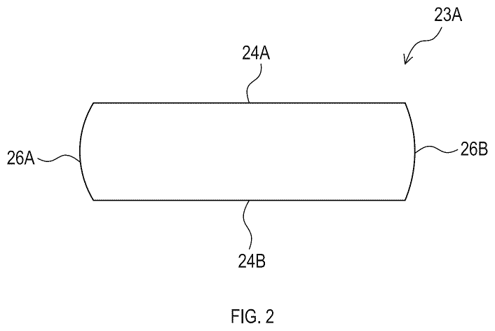

The round wire drawing machine 5 draws the conductor 23 having a circular cross-sectional shape. The flat rolling machine 7 performs the flat rolling on the conductor 23 travelling therethrough. The conductor 23 that has undergone the flat rolling is referred to as a flat copper wire 23A. As shown in FIG. 2, a cross-sectional shape of the flat copper wire 23A is a shape formed by two sides 24A and 24B parallel to each other and two arc-shaped lines 26A and 26B. In the cross section, the shape of the sides 24A and 24B is linear. In the cross section, the length of the sides 24A and 24B is longer than the length of the arc-shaped lines 26A and 26B. The annealing furnace 9 anneals the flat copper wire 23A.

The flat wire drawing machine 11 performs a flat wire drawing on the flat copper wire 23A travelling therethrough. The flat wire drawing is a process in which a cold wire drawing is continuously performed on the flat copper wire 23A using a flat wire drawing die. The conductor 23 that has undergone the flat wire drawing is the flat copper drawn wire 23B.

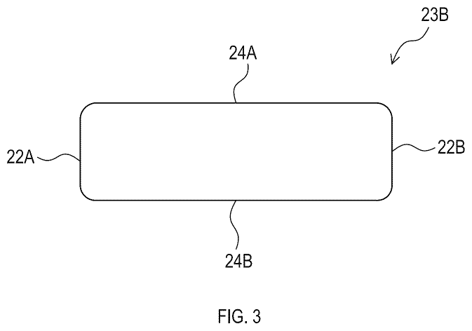

A cross-sectional shape of the flat copper drawn wire 23B is a rounded rectangle as shown in FIG. 3. Longer sides of the rounded rectangle are the sides 24A and 24B. Shorter sides 22A and 22B of the rounded rectangle are sides derived from the arc-shaped lines 26A and 26B, respectively, in the flat copper wire 23A.

As shown in FIG. 1, in the flat wire drawing machine 11 (in the manufacturing apparatus 1), a direction in which the conductor 23 travels is referred to as a traveling direction TR. An direction opposite to the traveling direction TR is referred to as an upstream direction US. The annealing furnace 13 anneals the flat copper drawn wire 23B. The coating material application machine 15 applies an enamel coating to a surface of the flat copper drawn wire 23B to thereby form a film of the enamel coating material of a given thickness on the surface of the flat copper drawn wire 23B.

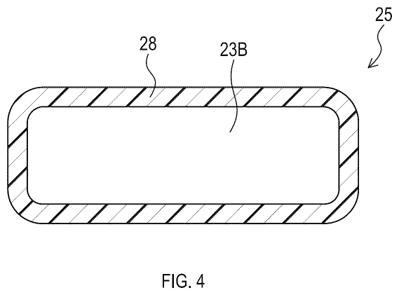

The baking furnace 17 heats and bakes the flat copper drawn wire 23B, which is now given a film of the enamel coating of a given thickness by the coating material application machine 15 and travels through the baking furnace 17, and thereby forms an insulation film 28 as shown in FIG. 4. As shown in FIG. 1, the application of the enamel coating by the coating material application machine 15 and the baking by the baking furnace 17 are repeatedly performed. The flat enameled copper wire 25 is then wound up by the winding machine 19.

The detailed method of forming the insulation film 28 is as follows. The coating material application machine 15 applies the enamel coating on the surface of the flat copper drawn wire 23B. The enamel coating includes a resin, a solvent, and an inorganic filler. The resin includes polyamic acid. The polyamic acid is a compound synthesized from a raw material containing an acid anhydride and diamine. The acid anhydride includes PMDA (pyromellitic dianhydride). The diamine includes ODA (4,4′-diamino diphenyl ether).

The raw material of polyamic acid further includes at least one kind from the following: BPDA (biphenyl-3,3′4,4′-tetracarboxylic dianhydride); TPE-R (1,3-bis(4-aminophenoxy) benzene); and BODA (4,4′-bis(4-aminophenoxy) biphenyl). BPDA is acid anhydride. TPE-R and ODA are diamine.

The storage modulus of the insulation film 28 at 370° C. is reduced by the raw material of polyamic acid further including at least one kind from BPDA, TPE-R, and BODA. The storage modulus of the insulation film 28 at 370° C. is further reduced as the content of at least one kind from BPDA, TPE-R, and BODA increases.

In the raw material of polyamic acid, the ratio of the number of moles of PMDA to the total number of moles of acid anhydride is preferably 40 mol % or more, more preferably 50 mol % or more, and particularly preferably 60 mol % or more.

The raw material of polyamic acid may contain BPDA. If the raw material of polyamic acid includes BPDA, the ratio of the number of moles of BPDA to the total number of moles of acid anhydride is preferably less than 60 mol %, more preferably less than 50 mol %, and particularly preferably less than 40 mol %.

In the raw material of polyamic acid, the ratio of the number of moles of ODA to the total number of moles of diamine is preferably 5 mol % or more, more preferably 10 mol % or more, and particularly preferably 15 mol % or more.

The raw material of polyamic acid may include TPE-R. If the raw material of polyamic acid includes TPE-R, the ratio of the number of moles of TPE-R to the total number of moles of diamine is preferably 3 mol % or more, more preferably 5 mol % or more, and particularly preferably 10 mol % or more.

The raw material of polyamic acid may include BODA. If the raw material of polyamic acid includes BODA, the ratio of the number of moles of BODA to the total number of moles of diamine is preferably 10 mol % or more, more preferably 60 mol % or more, even more preferably 70 mol % or more, and particularly preferably 80 mol % or more.

All of the monomers included in the raw material of polyamic acid are preferably aromatic monomers. The insulation film 28 has high heat resistance in this case. Examples of the solvent included in the enamel coating may include dimethylacetamide (DMAc) and N-Methylpyrrolidone (NMP). The mass ratio of the solid content in the enamel coating is, for example, 15 mass % or more and 30 mass % or less.

Examples of the inorganic filler included in the enamel coating may include silica, alumina, and titanium oxide. For example, the surface of the inorganic filler is processed with an organic substance. In this case, the inorganic filler has excellent dispersibility in polyimide. When the enamel coating is applied and baked, polyamic acid changes to polyimide. The insulation film 28 thus includes polyimide.

Since the enamel coating includes the inorganic filler, the insulation film 28 includes the inorganic filler. The surge resistance of the insulation film 28 is improved by the insulation film 28 including the inorganic filler. The amount of the inorganic filler blended in the enamel coating and thus in the insulation film 28 is preferably 1 phr or more and 100 phr or less, more preferably 5 phr or more and 80 phr or less, and particularly preferably 10 phr or more and 50 phr or less.

Next, the solvent in the enamel coating applied on the surface of the flat copper drawn wire 23B is evaporated, and the enamel coating is baked in the baking furnace 17. A single layer included in the insulation film 28 is formed after a single round of the application of the enamel coating by the coating material application machine 15 and the baking in the baking furnace 17. By repeating the application of the enamel coating by the coating material application machine 15 and the baking in the baking furnace 17, the insulation film 28 including laminates of multiple layers is formed. The insulation film 28 is thus formed as a result of the aforementioned processes, and accordingly, the flat enameled copper wire 25 is produced. The insulation film 28 includes polyimide generated from polyamic acid contained in the enamel coating. The insulation film 28 thus includes polyimide and the inorganic filler.

The raw material of polyamic acid corresponds to the raw material of polyimide. The raw material of polyimide includes PMDA and ODA. The raw material of polyimide further includes at least one kind from BPDA, TPE-R, and BODA.

### 2. Configuration of Flat Enameled Copper Wire 25

The configuration of the flat enameled copper wire 25 will be explained with reference to FIG. 4. The flat enameled copper wire 25 includes the flat copper drawn wire 23B, and the insulation film 28. The flat copper drawn wire 23B corresponds to the conductor. The insulation film 28 coats the flat copper drawn wire 23B. The thickness of the insulation film 28 is, for example, 30 μm or more and 200 μm or less.

The insulation film 28 includes polyimide and the inorganic filler. The storage modulus of the insulation film 28 at 370° C. is 0.9 GPa or less. Preferably, the storage modulus is 0.9 GPa or less at 370° C. in all of the layers forming the insulation film 28. The method of measuring the storage modulus of the insulation film 28 is as follows. An enamel coating containing the same components as the enamel coating of the insulation film 28 is applied on a PEEK base material and baked. Thus prepared insulation film is peeled off from the PEEK base material to prepare a measurement sample. The width of the measurement sample is 5 mm. The thickness of the measurement sample is 30 μm to 40 μm. Dynamic mechanical analysis (DMA) is performed under the following conditions. The measurement sample may be able to be prepared by peeling the insulation film 28 off from the flat enameled copper wire 25.
Distortion: 0.5%
Frequency: 10 Hz
Heating Rate: 10° C./min
Chuck Distance: 20 mm

### 3. Effects of Flat Enameled Copper Wire 25

Adhesiveness between the layers forming the insulation film 28 is high in the flat enameled copper wire 25. The reason thereof is inferred as follows. When the flat enameled copper wire 25 is stretched, the adhesiveness between the layers forming the insulation film 28 decreases if a residual stress is large inside the insulation film 28. Since the storage modulus of the insulation film 28 at 370° C. is low in the flat enameled copper wire 25, the residual stress is small. As a consequence, the adhesiveness between the layers forming the insulation film 28 is high.

The storage modulus of the insulation film 28 at 370° C. is low because the raw material of polyimide further includes at least one kind from BPDA, TPE-R, and BODA.

As a method of increasing the adhesiveness between the layers forming the insulation film 28, there is one in which the baking temperature during the coating process is increased while immensely lowering the traveling speed of the conductor 23. However, in this method, problems such as heat deterioration of the insulation film 28 and oxidization of the conductor 23 are likely to occur. In addition, in this method, the productivity of the flat enameled copper wire 25 is low. The flat enameled copper wire 25 according to the present disclosure can reduce the occurrence of the above problems in this method.

### EXAMPLES

### Manufacture of Enameled Copper Wire

Enameled copper wires of Examples 1 to 8 and Comparative Example 1 were manufactured by the method described in the first embodiment. However, the enameled copper wires were not rectangular wires but round wires. The methods of manufacturing the enameled copper wires of Examples 1 to 8 and Comparative Example 1 were different from each other in the raw material of polyamic acid included in the enamel coating and the blended amount of the inorganic filler in the enamel coating, but were otherwise the same.

The enamel coating included polyamic acid, the inorganic filler, and the solvent. The inorganic filler was colloidal silica, and the solvent was dimethylacetamide. The mass ratio of the solid content in the enamel coating was 15 mass % to 30 mass %.

In Examples 1 to 8 and Comparative Example 1, the kinds and the amounts of the raw materials of polyamic acid blended in the enamel coating were as shown in Table 1. The unit of the blended amount of the raw material is mol %. In Examples 1 to 8 and Comparative Example 1, the blended amounts of the inorganic filler in the enamel coating were as shown in Table 1.

TABLE 1

| | | | | | | Blended amount | Storage | |
|---|---|---|---|---|---|---|---|---|
| | Raw material of Polyamic acid/Polyimide | | | | | of inorganic | modulus | Length |
| | acid anhydride | | diamine | | | filler | at 370° C. | L |
| | PMDA | BPDA | ODA | TPE-R | BODA | (phr) | (GPa) | (mm) |
| Comparative Example 1 | 100 | — | 100 | — | — | 25 | 1.03 | 1.5 |
| Example 1 | 80 | 20 | 100 | — | — | 25 | 0.39 | 1.0 |
| Example 2 | 80 | 20 | 100 | — | — | 30 | 0.38 | 1.0 |
| Example 3 | 70 | 30 | 15 | — | 85 | 25 | 0.17 | 1.0 |
| Example 4 | 70 | 30 | 15 | — | 85 | 30 | 0.20 | 0.5 |
| Example 5 | 100 | — | 90 | 10 | — | 30 | 0.88 | 1.0 |
| Example 6 | 100 | — | 70 | 30 | — | 25 | 0.48 | 1.0 |
| Example 7 | 100 | — | 70 | 30 | — | 30 | 0.46 | 0.5 |
| Example 8 | 70 | 30 | 85 | — | 15 | 25 | 0.23 | 1.0 |

### 2. Measurement of Storage Modulus

A measurement sample was prepared for each of Examples 1 to 8 and Comparative Example 1 to measure their storage moduli.

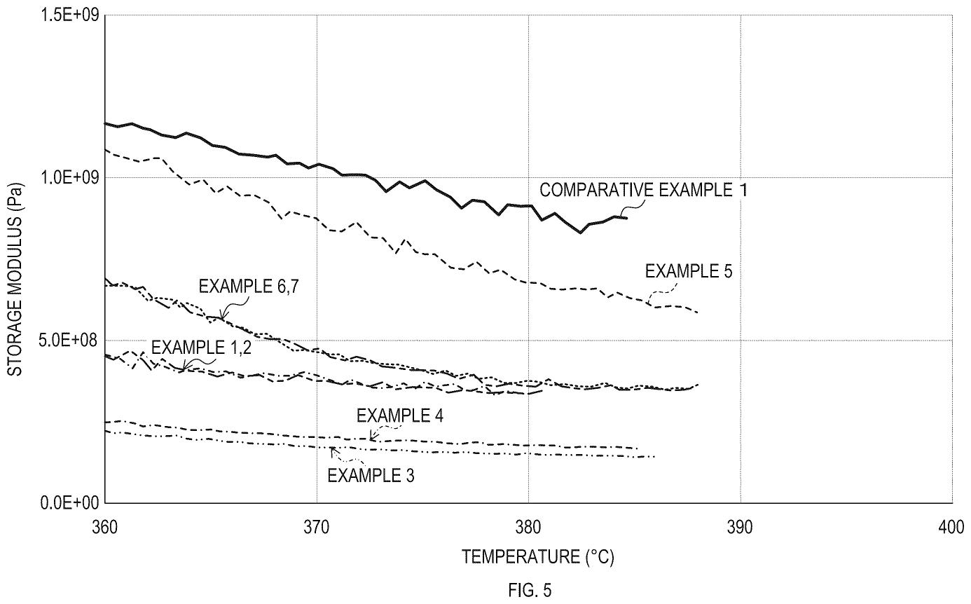

The storage moduli were measured by the aforementioned method using the measurement samples. Transitions of the temperatures and the storage moduli during the measurements were shown in FIG. 5. Table 1 shows the results of the measurements of storage moduli at 370° C. The storage modulus at 370° C. was low in each of Example 1 to 8, but high in Comparative Example 1.

### 3. Cut and Stretch Test

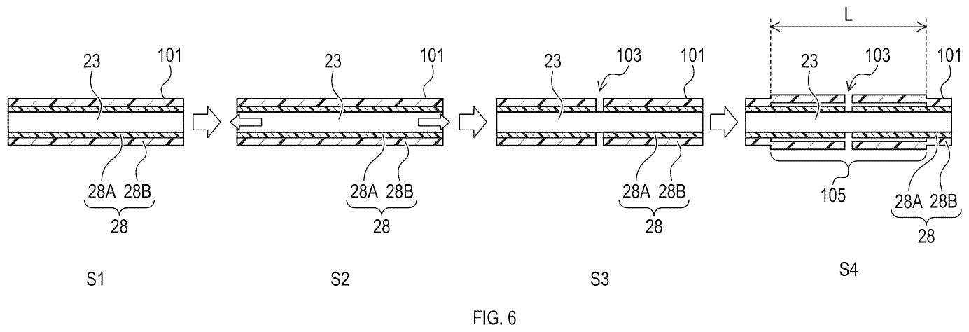

For each of Examples 1 to 8 and Comparative Example 1, a cut and stretch test was performed. The cut and stretch test evaluates the adhesiveness between the layers forming the insulation film 28. Firstly, as shown in S1 in FIG. 6, a measurement sample 101 was prepared. The measurement sample 101 was prepared by cutting the enameled copper wire to a length of 200 mm. The cut surface was the cross section of the enameled copper wire.

Subsequently, as shown in S2 in FIG. 6, the measurement sample 101 was stretched by 40% in its longitudinal direction. Then, as shown in S3 in FIG. 6, a cut 103 is formed in the measurement sample 101. The cut 103 was situated at the center of the measurement sample 101 in its longitudinal direction. The cut 103 extends in a circumferential direction of the measurement sample 101 along the entire circumference of the measurement sample 101. The cut 103 is formed from the surface of the insulation film 28 and reached the surface of the conductor 23.

After forming the cut 103, a peel-off area 105 resulted around the cut 103 as shown in S4 in FIG. 6. The peel-off area 105 is an area where an inner layer 28A and an outer layer 28B of the insulation film 28 are removed from each other. The peel-off area 105 is visually recognizable from outside of the measurement sample 101. The length L of the peel-off area 105 was measured. The length L is the length of the measurement sample 101 in its longitudinal direction. The results of the measurement of the length L are shown in Table 1.

The length L was short in each of Examples 1 to 8 but was long in Comparative Example 1. The shorter the length L is, the higher the adhesiveness between the layers forming the insulation film 28. Thus, the adhesiveness between the layers forming the insulation film 28 was high in each of Examples 1 to 8 but was low in Comparative Example 1.

### Other Embodiments

Although the embodiment of the present disclosure has been explained above, the present disclosure can be implemented in various modifications without being limited to the aforementioned embodiment.

(1) The insulated wire may be any insulated wire other than the enameled wire.

(2) Among the layers forming the insulation film 28, at least one layer situated right on the conductor 23 may be an adhesion layer that includes polyimide but does not include the inorganic filler. The adhesion layer is a layer that contacts the conductor 23. The layer situated on the outside of the adhesion layer is a surge resistant layer that includes polyimide and the inorganic filler. In this case, the insulated wire of the present disclosure can increase the adhesiveness between the adhesion layer and the surge resistant layer. In addition, the insulated wire of the present disclosure can increase the adhesiveness between the surge resistant layers. Since the adhesion layer does not include the inorganic filler, the adhesiveness between the conductor 23 and the adhesion layer is high.

(3) Functions of one element in each of the aforementioned embodiments may be distributed to two or more elements; and functions of two or more elements in each of the aforementioned embodiments may be performed by one element. A part of the configurations of the aforementioned embodiments may be omitted. At least a part of the configurations of each of the aforementioned embodiments may be added to or replaced with other configurations of the aforementioned embodiments.

(4) Other than the aforementioned insulated wire, the present disclosure can be realized in various forms such as a product including the insulated wire as an element, a method for manufacturing the insulated wire, and the like.

What is claimed is:

1. An insulated wire, comprising:
a conductor; and
an insulation film coating the conductor,
the insulation film including polyimide and an inorganic filler, and
a storage modulus of the insulation film at 370° C. being 0.9 GPa or less.

2. The insulated wire according to claim 1,
wherein a raw material of the polyimide includes pyromellitic dianhydride and 4,4′-diamino diphenyl ether, and
wherein the raw material further include at least one kind from biphenyl-3,3′4,4′-tetracarboxylic dianhydride, 1,3-bis(4-aminophenoxy) benzene, and 4,4′-bis(4-aminophenoxy) biphenyl.

3. The insulated wire according to claim 1,
wherein, among layers forming the insulation film, a layer that contacts the conductor includes the polyimide but does not include the inorganic filler.
